(19) United States
(12) Patent Application Publication
(10) Pub. No.: US 2010/0054867 A1
(43) Pub. Date: Mar. 4, 2010

(54) MESOPOROUS MICROPARTICLE AGGREGATES AND METHODS OF MAKING AND USING THE SAME

(76) Inventor: KWANGYEOL LEE, Namyangju-si (KR)

Correspondence Address: EDWARDS ANGELL PALMER & DODGE LLP, P.O. BOX 55874, BOSTON, MA, 02205, US

(21) Appl. No.: 12/202,050

(22) Filed: Aug. 29, 2008

(51) Int. Cl. A01B 79/02

(52) U.S. Cl. 405/263; 423/335; 423/337; 504/187; 47/48.5

(57) ABSTRACT

An aggregate of mesoporous microparticles that comprises two or more of covalently bound mesoporous microparticles is described. The aggregate of mesoporous microparticles can be used for many applications, including slowing or reversing desertification.

### BACKGROUND

Microstructured materials have distinguished themselves from those of bulk materials due to their size- and shape-dependent electronic, magnetic, optical, and catalytic properties.

Porous materials are classified into several kinds by their size. According to the International Union of Pure and Applied Chemistry (IUPAC) notation, a microporous material is in general a material having pores whose diameters are less than 2 nanometers (nm). A macroporous material is in general a material having pores with diameters of greater than 50 nm. Therefore, a mesoporous material is in general a material having pores with diameters ranging from about 2 nm to about 50 nm, which are between the sizes of the pores of the two other porous materials.

Microstructured materials with pores have received considerable attention for their potential ability as catalysts, drug delivery agents, adsorbents, ion-exchange media, microcomposites, and confinement of electronic materials.

### SUMMARY

One embodiment relates to an aggregate of mesoporous microparticles. The aggregate includes one or more first mesoporous microparticles associating or bound with one or more second mesoporous microparticles. In some aspects the one or more first mesoporous microparticles and the one or more second mesoporous microparticles can be homogenous or of a same form or type. For example, the one or more first and second mesoporous nanoparticles can be composed of the same material, be roughly the same size, be the same shape, include the same material (e.g., water or a target material), etc. In some aspects, the one or more first mesoporous microparticles and the one or more second mesoporous microparticles can be heterogenous or of a different form or type. For example, the one or more first microparticles can be composed of a different material, can be a different shape, can be a different size, can include a different material (e.g., water or target material), etc.

In another embodiment, a method of making the aggregate of mesoporous microparticles includes adding a reactive group to a first mesoporous microparticle and to a second mesoporous microparticle. The reactive groups can then be reacted to bind the first and second mesoporous microparticles.

Still other embodiments relate generally to a method of making a water-containing mesoporous microparticle aggregate. This method includes contacting the mesoporous microparticle aggregate with water. Some other aspects relate to a method of making a target material-containing mesoporous microparticle aggregate, which includes contacting a mesoporous microparticle aggregate with the target material. In some of these embodiments, the target material can be a material such as a fertilizer, a pesticide, an herbicide, a fungicide, a biocide, a probiotic, and combinations thereof.

In addition, in certain embodiments, the aggregates of mesoporous microparticles that include water or a target material are used to retain water in soil and/or promote growth of a plant. Moreover, in some embodiments, the aggregates of mesoporous microparticles that include water or a target material are used to slow desertification of a land that is at risk of becoming a desert or to reverse desertification that has already occurred is presented.

The foregoing is a summary and thus contains, by necessity, simplifications, generalization, and omissions of detail; consequently, those skilled in the art will appreciate that the summary is illustrative only and is not intended to be in any way limiting. Other aspects, features, and advantages of the devices and/or processes and/or other subject matter described herein will become apparent in the teachings set forth herein. The summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

### BRIEF DESCRIPTION OF THE DRAWING

The foregoing and other features of the present disclosure will become more fully apparent from the following description and appended claims, taken in conjunction with the accompanying drawings. Understanding that the drawings depict only several embodiments in accordance with the disclosure and are, therefore, not to be considered limiting of its scope, the disclosure will be described with additional specificity and detail through use of the accompanying drawings.

FIG. 1 is a depiction of an illustrative embodiment of adding a chemical reactive group such as —OH group to mesoporous nanoparticles.

FIGS. 2A, 2B and 2C are depictions of an illustrative embodiment of making an aggregate of mesoporous nanoparticles.

### DETAILED DESCRIPTION

In the following detailed description, reference is made to the accompanying drawings, which form a part hereof In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the Figures, can be arranged, substituted, combined, and designed in a wide variety of different configurations, all of which are explicitly contemplated and make part of this disclosure.

Some of aspects of the disclosure relate generally to an aggregate of mesoporous microparticles and their use in various applications, including, but not limited to, increasing water-retention in soils, promoting plant growth, slowing desertification of a land that is at risk of becoming a desert and reversing desertification that has already occurred.

Generally, a mesoporous microparticle is a microparticle that includes one or more pores, wherein at least one of the one or more pores is a mesopore. The diameter of a mesopore is in general from about 2 to about 50 nm. In one example, the mesoporous microparticle can have one or more pores, in which all of the one or more pores are mesopores. In another example, the mesoporous microparticle can have at least two pores, wherein at least one of the at least two pores is a mesopore and at least another of the at least two pores is a micropore. The diameter of a micropore is in general larger than 0 nm and less than about 2 nm. In still another example, the mesoporous microparticle can have at least two pores, wherein at least one of the at least two pores is a mesopore and at least another of the at least two pores is a macropore. The diameter of a macropore is in general larger than 50 nm. In some embodiments, the mesoporous microparticle has one or more pores, wherein at least one of the one or more pores is a mesopore and the other pores of the one or more pores, if there is more than one pore, are mesopores, micropores, macropores or any combinations thereof.

A microparticle can be shaped in a variety of morphologies, including for example, a layer or sheet, a cylinder, a sphere, a cube, a rod, a tubular structure, a fiber, any type of hexahedrons, any of regular or irregular shaped two-dimensional structures, and any of regular or irregular shaped three-dimensional structures.

In general, the average size along at least one dimension (e.g. diameter, width, length or height) of the microparticle used in connection with certain embodiments of this disclosure can be, for example, from about 1 micrometer (μm) to about 1,000 μm. The average size, measured along any dimension (e.g. diameter, width, length or height) of the microparticle used in connection with certain embodiments of this disclosure can be, for example, in the range from about 1 μm, 10 μm, or 100 μm to about 10 μm, 100 μm or 1,000 μm or any value in between the listed numbers.

There are various methods that can be used to generate many different kinds of mesoporous microparticles. Examples of such processes of making mesoporous microparticles include, but are not limited to, a self-assembly method, a templated self-assembly method, and a sol-gel processing method. These and other methods are known to those of ordinary skill in the art. In addition, modification of certain conditions and components during the production of mesoporous microparticles can influence physical properties of the microparticle, such as the size and shape of the microparticle, the size of the pore, the morphology of the pore and others. Therefore, methods of producing the desired mesoporous microparticles can be selected, for example, taking into consideration a purpose for which they are to be used.

In general, the source material for the mesoporous microparticles is not limited. The mesoporous microparticles can include any material capable of forming a mesoporous microparticle, including but not limited to silica, carbon, other like substances, or a combination thereof. In certain embodiments, the mesoporous microparticle can include silica. Furthermore, any surfactants, metals such as but not limited to aluminum, and other source materials that can be used for producing any size and shape of mesoporous microparticles are expressly contemplated.

In certain embodiments, the density of the mesoporous microparticle can be, for example, greater than 0.0 grams per milliliter (g/ml) and equal to or less than 1.5 g/ml. In some embodiments, the density can be, for example, greater than 0.0 g/ml, 0.25 g/ml, 0.5 g/ml, 0.75 g/ml, 1.0 g/ml, or 1.25 g/ml and equal to or less than 0.25 g/ml, 0.5 g/ml, 0.75 g/ml, 1.0 g/ml, 1.25 g/ml or 1.5 g/ml.

Advantageously, in some embodiments, the physical and chemical features and structures of the mesoporous microparticles can remain unchanged even at temperatures ranging from about −30° C. to about 1,500° C. In some of these embodiments, the physical and chemical features and structures of the mesoporous microparticles remain unchanged, for example, at temperatures between about −10° C. to about 1,200° C. In some other embodiments, the physical and chemical features of the mesoporous microparticles are unchanged at temperatures between about 0° C. to about 1,000° C.

The mesoporous microparticle can maintain its porous structure, for example, generally for about several (e.g. ten) hours to about several (e.g. ten) years. The mesoporous microparticle can maintain a porous structure for about 3 hours, 3 months, 6 months, 12 months, or 24 months to about 3 months, 6 months, 12 months, 24 months or several (e.g. ten) years, for example.

Some embodiments relate to an aggregate of mesoporous microparticles. As used herein, an aggregate can include, for example, at least two or more mesoporous microparticles. In some embodiments, aggregation occurs by inducing one or more chemical bonds, for example, covalent bonds that associate two or more mesoporous microparticles. Other types of chemical bonds also are contemplated as discussed more fully elsewhere herein.

To produce an aggregate of mesoporous microparticles, the mesoporous microparticles can be synthesized via any method described herein or known in the art. In addition, two or more mesoporous microparticles such as, but not limited to, MCM-41, which has multiple pores with diameters from about 1.5 to about 10 nanometers, and/or SBA-15, which has one or more pores, with diameters of from about 4 to about 300 nanometers, may be used to produce the disclosed aggregates. Aggregates of mesoporous microparticles can be advantageous for reasons including, but not limited to, safety issues relating to their increased size.

In some embodiments, two or more mesoporous microparticles are aggregated to become an aggregate. In an illustrative embodiment, the number of mesoporous microparticles aggregated to become the aggregate can be, for example, between about 10 and about 1,000,000. For example, the aggregates can include about 10, 100, 1,000, 10,000, or 100,000 to about 100, 1,000, 10,000, 100,000 or 1,000,000, or any number there between.

In one embodiment, at least one mesoporous microparticle can be associated with at least one other mesoporous microparticle to form the aggregate. The mesoporous microparticles associated with each other can be of the same or different form (i.e. size, shape, material, etc.). In this embodiment, the mesoporous microparticles can be associated with each other through a variety of different linkages or interactions. For example, a covalent bond between the mesoporous microparticles can be formed, as described in more detail below. However, in some cases, an ionic bond, a hydrogen bond, or a bond due to Van der Waals attraction also can be formed. Hydrophilic and/or hydrophobic interaction between molecules bound to the surface of the mesoporous microparticles can also associate the mesoporous microparticles with each other. In some other cases, the mesoporous microparticles can also associate with each other through an adsorption process.

The mesoporous microparticles making up the aggregates can be synthesized by any method described herein or known to those having ordinary skill in the art. The aggregates can be composed of the same or different forms of mesoporous microparticles. One class of mesoporous materials is reported in U.S. Pat. Nos. 5,057,296 and 5,102,643, the complete disclosures of which are hereby incorporated by reference herein in their entireties. Thus, in some embodiments, each of the mesoporous microparticles can be independently selected from members of this class, including but not limited to MCM-41, MCM-48, MCM-50, and/or SBA-15.

In various embodiments, the average size along any dimension (e.g. diameter, circumference, length, width or height) of the aggregate of mesoporous microparticles can be, for example, from about 0.1 millimeter (0.1 mm) to about 100 centimeters (cm). The average size of the aggregate can be, for example, from about 0.1 mm to about 100 cm. For example, the average size can be from about 0.1 nm, 0.5 mm, 1 mm, 1 cm, 5 cm, 10 cm, 20 cm, 30 cm, 40 cm, 50 cm, 60 cm, 70 cm, 80 cm, or 90 cm to about 0.5 mm, 1 mm, 1 cm, 5 cm, 10 cm, 20 cm, 30 cm, 40 cm, 50 cm, 60 cm, 70 cm, 80 cm, 90 cm, or 100 cm.

During the process of manufacturing, the aggregate can initially be made larger than the final size of the aggregate, then it can be further processed to achieve the final size. For example, an aggregate of mesoporous microparticles can initially be made in the form of a sphere-shaped aggregate with an average diameter of about 50 mm. If an aggregate with an average diameter of 1 mm is desired as the final product, the 50 mm aggregate can be processed to an average size of 1 mm via methods including but not limited to crushing, cutting, sonication, microfluidizing, or other feasible method, known to those having ordinary skill in the art.

In some embodiments, methods of aggregating two or more mesoporous microparticles are provided. For example, in some illustrative examples, a chemically reactive group can be added to a mesoporous microparticle. The chemically reactive group can be any of various reactive groups that can be linked covalently. Some illustrative examples of chemically reactive groups are —OH, —COOH, —NH₂, —CH₂OH, —CH₂CH₂OH, —CH₃CHOH, and any other chemical reactive groups that can make a chemical bond such as a covalent bond between each other or with other chemically reactive group(s). In certain illustrative embodiments, a chemical bond associating mesoporous microparticle can be a covalent bond. In such embodiments, a covalent bond means a chemical bond that is characterized by sharing of pairs of electrons between atoms.

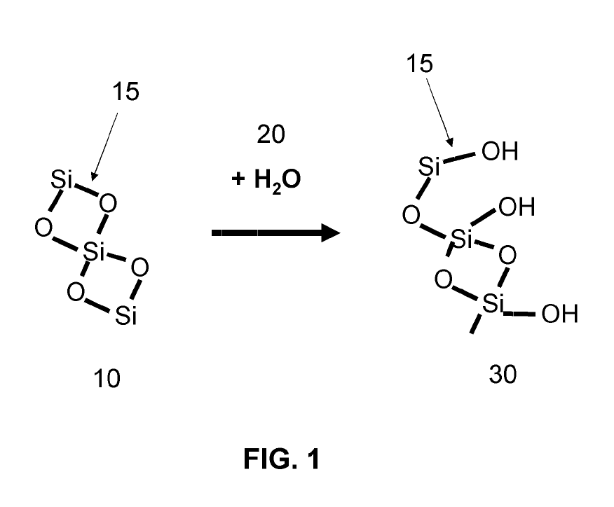

In an illustrative example, the reactive group can be, for example, a hydroxyl group or —OH group and the mesoporous microparticle is a mesoporous microparticle that includes silica. For example, FIG. 1 provides a depiction of an illustrative embodiment of adding a chemical reactive group such as —OH group to mesoporous nanoparticles. FIG. 1 shows a mesoporous microparticle that includes an oxide of silica, SiO₂ 10 (Si: silica; O: oxygen). One or more Si are connected with one or more O via covalent bonds 15. When water 20 reacts with SiO₂ 10, at least some of covalent bonds 15 between Si and O can be broken and a —OH group can be connected to Si forming Si—OH 30. Two or more of the silica mesoporous microparticles can be aggregated by forming covalent bonds between —OH groups on two silica mesoporous microparticles resulting in a chemical structure between the two aggregated particles of —Si—O—Si.

One embodiment of adding —OH groups to the separate silica mesoporous microparticles can generally be conducted as follows:
heating 10 kg of the silica mesoporous microparticles in 500 g of water (or any solution that can provide —OH groups) at temperatures ranging about 70° C. to about 150° C. for about 30 minutes to about 24 hours to generate the silica mesoporous microparticles having the —OH group.

In this particular example, heating the mesoporous microparticles in water or other solutions that can provide —OH groups, can result in adding the —OH groups to any part of the microparticles, including the surface of the microparticles.

Two or more silica mesoporous microparticles can be aggregated by forming covalent bonds between —OH groups on two silica mesoporous microparticles, resulting in a chemical structure between the two aggregated particles of —Si—O—Si. For example, two or more —OH groups present on the separate silica mesoporous microparticles can be reacted to form a covalent bond by
physically pressing together the silica mesoporous microparticles having —OH groups, at temperatures ranging from about 70° C. to about 500° C. for about 30 minutes to 24 hours, under pressures ranging from about 0.1 Psi to about 100 Psi.

Physically pressing together such microparticles with —OH groups, in temperatures ranging about 70° C. to about 500° C., can cause a covalent linkage between —OH groups present on separate microparticles thereby resulting in an aggregate with a structure of —Si—O—Si—.

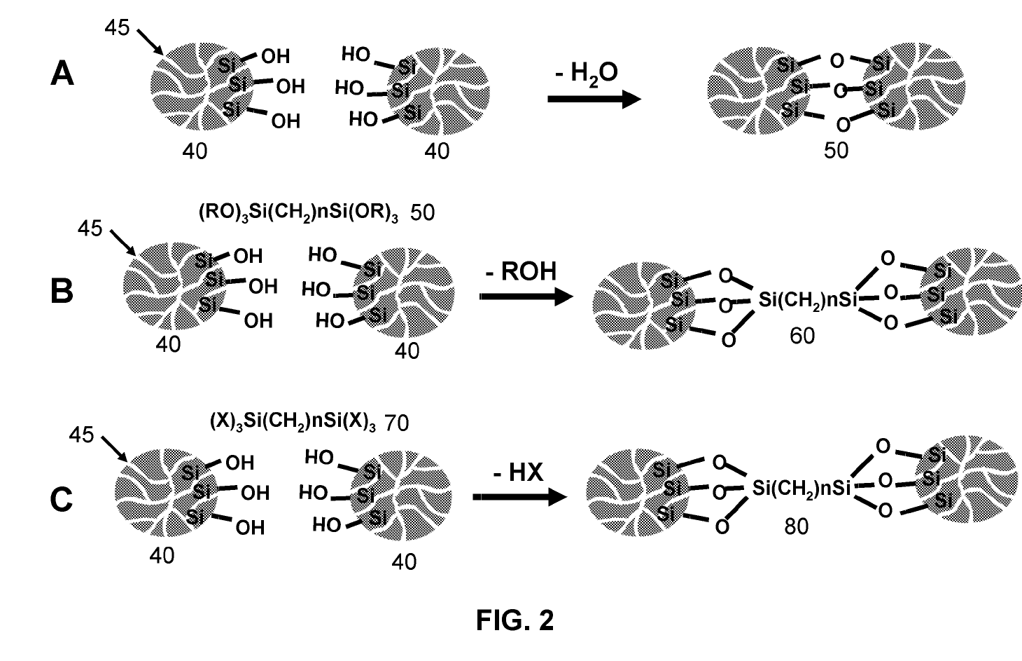

An illustration of this example is presented in FIG. 2A. The mesoporous particle 40 has a number of mesopores 45. The mesopores 45 can be connected to each other as shown in FIG. 2A or exist separately (not shown). Also the mesopores 45 can have openings as illustrated in FIG. 2A or can be embedded inside the microparticle without having openings (not shown). Two or more of the mesoporous microparticles with an —OH group 40 can react with each other so as to generate water and aggregates of mesoporous microparticles 50. In the particular example illustrated in FIG. 2A, the mesoporous particles can be formed primarily of silica, for example. Thus, in the embodiment shown, the aggregates 50 can be formed by association of the mesoporous particles via Si—O—Si covalent bonds.

Advantageously, in the illustrated example, heating and pressing the mesoporous microparticles does not generally influence the porosity of the mesoporous microparticles. Nevertheless, even if the porosity is somewhat affected, as can occur in other examples, routine experimentation can be carried out to determine conditions under which the microparticles in the aggregate will retain their mesoporous character, i.e. at least one mesopore remains present.

In another embodiment, two or more —OH groups present on silica mesoporous microparticles can be reacted to form a covalent bond by
immersing the mesoporous microparticles with —OH groups in an organic solvent, such as an alcohol; and
reacting the mesoporous microparticles with —OH groups in the solvent with (RO)₃Si(CH₂)nSi(OR)₃ at temperatures ranging from about 10° C. to about 80° C. for about 12 hours to 24 hours, wherein R represents an alkyl group including, but not limited to a methyl or ethyl group, and n represents any number between 1 to 20.

In this particular example, any kind of organic solvent can be used to immerse the mesoporous microparticles. In some embodiments, an alcohol can be used as an example of organic solvents. The kind of alcohol that can be used includes, but is not limited to, ethanol, methanol, propanol, butanol, octanol, and the like, as well as combinations thereof. In some of these embodiments, the temperature range for reacting mesoporous microparticles with —OH groups in alcohol with (RO)₃Si(CH₂)nSi(OR)₃ is generally from about 10° C., 20° C., 30° C., 40° C., 50° C., 60° C., or 70° C. to about 20° C., 30° C., 40° C., 50° C., 60° C., 70° C. or 80° C. Immersing the mesoporous microparticles with —OH groups in any kind of organic solvent, and/or reacting mesoporous microparticles with —OH groups in alcohol with (RO)₃Si(CH₂)nSi(OR)₃, generally does not influence the porosity of the mesoporous microparticles. However, even if the porosity is affected, such immersing and reacting methods can be carried out in a manner such that the microparticles in the aggregate retain their mesoporous character, i.e. at least one mesopore remains present. The illustration of this example is presented in FIG. 2B. The mesoporous particle 40 has one or more mesopores 45. The mesopores 45 can be connected to each other as shown in FIG. 2B or exist separately (not shown). Also, the mesopores 45 can have openings as illustrated in FIG. 2B or be embedded inside the microparticle without having openings (not shown). When (RO)₃Si(CH₂)nSi(OR)₃ 50 is present, Si in this (RO)₃Si(CH₂)xSi(OR)₃ 50 and another Si in the mesoporous microparticle 40 can be associated to generate the aggregate 60. In general, two or more mesoporous microparticles with —OH groups can react with one or more (RO)₃Si(CH₂)nSi(OR)₃ 60 so as to generate aggregates of mesoporous microparticles 60.

In other embodiments, two or more —OH groups present on silica mesoporous microparticles can be reacted to form a covalent bond by
immersing the mesoporous microparticles with —OH groups in any kind of organic solvent, such as alcohol; and
reacting the mesoporous microparticles having —OH groups in alcohol with (X)₃Si(CH₂)nSi(X)₃ at temperatures ranging from about 10° C. to about 80° C. about 12 hours to 24 hours, wherein X represents an halide element such as but not limited to, fluoride, chloride, bromide, iodide, or astatide, and n represents any number between 1 to 20.

In this particular example, any kind of organic solvent can be used to immerse the mesoporous microparticles. In some embodiments, an alcohol can be used as an example of an organic solvent. Examples of alcohols that can be used herein include, but are not limited to, ethanol, methanol, propanol, butanol, octanol, combinations thereof, and the like. In some of these embodiments, the temperature range for reacting mesoporous microparticles with —OH groups in alcohol with (X)₃Si(CH₂)nSi(X)₃ is generally from about 10° C., 20° C., 30° C., 40° C., 50° C., 60° C., or 70° C. to about 20° C., 30° C., 40° C., 50° C., 60° C., 70° C. or 80° C. Immersing the mesoporous microparticles with —OH groups in any kind of organic solvent, and/or reacting mesoporous microparticles with —OH groups in alcohol with (X)₃Si(CH₂)nSi(X)₃, generally does not influence the porosity of the mesoporous microparticles. However, even if the porosity is affected, such immersing and reacting methods can be carried out in a manner such that the microparticles in the aggregate retain their mesoporous character, i.e. at least one mesopore remains present. The illustration of this example is presented in FIG. 2C. The mesoporous particle 40 has one or more mesopores 45. The mesopores 45 can be connected to each other as shown in FIG. 2C or exist separately (not shown). Also the mesopores 45 can have openings as illustrated in FIG. 2C or be embedded inside the microparticle without having openings (not shown). When (X)₃Si(CH₂)nSi(X)₃ 70 is present, Si in this (X)₃Si(CH₂)nSi(X)₃ 70 and another Si in the mesoporous microparticle 40 can be associated to generate the aggregate 80. In general, two or more mesoporous microparticles with —OH groups can react with one or more (X)₃Si(CH₂)nSi(X)₃ 70 so as to generate aggregates of mesoporous microparticles 80.

The aggregates of mesoporous microparticles can be shaped in many different ways. Shapes include, but are not limited to, spheres, rods, fibers, elongated tubes, irregular shaped particles, plates, and others. Also the compactness, size, width, length, diameter, etc. of such variously shaped aggregates can be highly variable and controlled according to the particular method of manufacture. For example, the number of mesoporous microparticles can be varied depending on the desired size of the aggregate and the compactness of the aggregate (i.e. the number of mesoporous microparticles per unit volume). In one illustrative example, one can assemble about 1,000,000 mesoporous microparticles with —OH groups and apply physical pressure to aggregate the mesoporous microparticles. In another illustrative example, about 100,000 mesoporous microparticles with —OH groups can be assembled, and a similar amount of physical pressure applied to aggregate the mesoporous microparticles. If a similar number of aggregates is generated in the foregoing two examples, the manufacturing method using about 100,000 mesoporous microparticles can generally generate aggregates about 90% smaller in volume than are generated by a method using about 1,000,000 mesoporous microparticles.

In another example, the shape of the aggregate can be manipulated. If a physical pressing method is applied to aggregate mesoporous microparticles with —OH groups, depending on how the physical pressure is applied, the aggregate can be shaped into any of a large variety of shapes, including a plane, sphere, irregular shapes, and others. In one example, pressing and shaping the aggregate can be conducted through the use of shaped frames. If, as an example, a plane of aggregates is desired, about 1,000 to 1,000,000 mesoporous microparticles with OH groups can be placed into a square-shaped frame. Then, physical pressure may be applied to aggregate and further shape the aggregate into the square-shaped plane. Once aggregation occurs and aggregates having a desired size, such as about 10 cm to 100 cm in a diameter, are obtained, the aggregates can be optionally further processed into a variety of differently shaped- or sized-aggregates. Thus, in one example, if aggregates having a diameter of about 0.1 cm are desired as a final product, one can further crush, cut, sonicate, and/or microfluidize to obtain about 0.1 cm diameter sized-aggregates from initially-produced aggregates having at least one dimension from about 10 cm to 100 cm.

In some embodiments, the aggregate of mesoporous microparticles can include water. For example, the water can be present within one or more pores in the aggregate. One illustrative way of providing water to the pores is to contact the aggregate with water or a solution that that includes water and permitting the water to enter the pores, for example, via capillary action. In one such illustrative example, the aggregate of mesoporous microparticles can simply be soaked in water. This soaking process can allow water to enter the pores via capillary action. In one embodiment, the aggregate of mesoporous microparticles can be soaked in water or a solution that includes water for about several (e.g. ten) seconds to about several (e.g. ten) months. The aggregate of mesoporous microparticles can be soaked in water or a solution that includes water, for example, for about several seconds, minutes, hours, days, or months to about several minutes, hours, days, months, or years.

In some embodiments, the weight of the water or solution can be about 10% to about 90% of the weight of the dry aggregate of mesoporous microparticles. In general, the weight of the water or solution can be, for example, about 10%, 20%, 30%, 40%, 50%, 60%, 70%, 80% to about 20%, 30%, 40%, 50%, 60%, 70%, 80%, or 90% of the weight of the dry aggregate of mesoporous microparticles. In some other embodiments, the weight of the water is about 50% of the weight of the dry aggregate of mesoporous microparticles.

In some embodiments, the aggregate of mesoporous microparticles can include a target material, for example, one or more of the following ingredients: a fertilizer, a pesticide, an herbicide, a fungicide, a biocide, a probiotic, and combinations thereof. For example, the fertilizer can be include or be nitrogen, phosphorus, potassium, calcium, sulfur, magnesium, boron, chlorine, manganese, iron, zinc, copper, molybdenum, selenium and combinations thereof. A pesticide, an herbicide, a fungicide, a biocide, and a probiotic can be, for example, a chemical material, a biological material produced or extracted from living organisms, a synthetic or natural toxin, any kind of active microorganisms and combinations thereof.

The target materials can be introduced into the mesoporous microparticles in a manner similar to that described above for introducing water into the particles. For example, a solution of water or other solvent that includes the target material(s) can be contacted with the mesoporous microparticles so that the solution enters the pores, for example by capillary action.

One illustrative method of producing the aggregate of mesoporous microparticles that includes the target material can include, for example, optionally making the target material in a liquid or a gel state, and contacting the target material in the liquid or the gel state with the aggregate. Upon contact, the target material can enter the pores, for example, by capillary action.

In an illustrative embodiment, the target material can be dissolved in water, aqueous solution, oil, organic solvents, any kind of liquid materials that can dissolve the fertilizer partially or completely and combinations thereof. Alternatively, the target material can be heated with temperatures ranging generally from about 50° C. to about 150° C. to convert the target material to liquid or gel, for example, if the fertilizer can transform into liquid or gel by heating. The target material can also be mixed with agents such as, but not limited to, agarose and gelatin, to form a gel consistency. In some embodiments, gel is a colloidal state of the material that is in jelly-like state.

The target material in either liquid or gel state can be mixed with the aggregate of mesoporous microparticles. In some embodiments, this mixing process itself allows the target material to enter the pores e.g. via capillary action. In some embodiments, the aggregate of mesoporous microparticles can be mixed with the target material, for example, for about several (e.g. ten) seconds to about several (e.g. ten) months. The aggregate of mesoporous microparticles can be mixed with the target material for about several seconds, minutes, hours, days, or months to about several minutes, hours, days, months, or years.

In some embodiments, the weight of the target material can be, for example, about 10% to about 90% of the weight of the dry aggregate of mesoporous microparticles. In general, the weight of the target material can be, for example, about 10%, 20%, 30%, 40%, 50%, 60%, 70%, 80% to about 20%, 30%, 40%, 50%, 60%, 70%, 80%, or 90% of the weight of the dry aggregate of mesoporous microparticles. In some other embodiments, the weight of the target material can be about 50% of the weight of the dry aggregate of mesoporous microparticles.

Some embodiments relate to the use of the mesoporous microparticle aggregates, for example, to increase water-retention in soil, promote plant growth, slow desertification of a land that is at risk of being a desert, and reversal of desertification. In order to increase water-retention in soil, an aggregate of mesoporous microparticles containing water or a water-based solution or solvent can be used. The amount of water that is need or that can be used is discussed below.

Advantageously, water captured in the aggregate of mesoporous microparticles can generally be released more rapidly when the water concentration in the environment of application areas is low. In some embodiments, the release rate of water from the aggregate can in part be correlated with the humidity in the environment of application areas. In dry soil or in dry weather conditions, water captured in the aggregate may be released more rapidly due to enhanced evaporation. In wet soil or under humid weather conditions, water captured in the aggregate may evaporate more slowly and be retained longer inside the aggregate. Moreover, in some embodiments of the mesoporous microparticle aggregates, when water concentration in the air and/or soil is high, water in the air or soil may enter the pores of the aggregate to be retained inside the pores and released when the environment subsequently becomes drier. Therefore, the amount of water and the time of water-retention in soil can generally be substantially increased by using water-containing aggregates of mesoporous microparticles as described herein.

In addition, water-containing aggregates of mesoporous microparticles can be applied to any area or subject that is in contact with soil. Examples of such areas or subjects that can contact soil include, but are not limited to, rocks, plants, seeds, and irrigation water.

In some embodiments, the water-containing aggregate can be applied to plants and seeds. Any amount of aggregate can be used according to the particular growth environment, conditions, etc. In one example, when seeds are buried or plants are planted in soil, about 0.1 g to equal to or less than 10 g of the aggregate comprising water can be buried close to seeds and roots of plants. In another example, when seeds are buried or plants are planted in soil, more than 10 g to equal to or less than 25 g of the aggregate comprising water can be buried close to seeds and roots of plants. For some other example, when seeds are buried or plants are planted in soil, more than 25 g to about 50 g of the aggregate comprising water can be buried close to seeds and roots of plants. Therefore, water can be provided to seeds and plants for an extended time period such as several (e.g. ten) seconds to several (e.g. ten) years.

Generally, the average time to at least partially release water captured in the aggregate of mesoporous microparticles is from about several (e.g. ten) seconds to about several (e.g. ten) years, or even longer when retained in moist environments. In certain embodiments, the average time to at least partially release water captured in the aggregate of mesoporous microparticles can generally be is about several (e.g. ten) seconds, several (e.g. ten) minutes, several (e.g. ten) hours, several (e.g. ten) days, several (e.g. ten) weeks, or several (e.g. ten) months to about several (e.g. ten) minutes, several (e.g. ten) hours, several (e.g. ten) days, several (e.g. ten) weeks, several (e.g. ten) months, or several (e.g. ten) years. In some embodiments, the average time to at least partially release water captured in the aggregate of mesoporous microparticles can generally be about several (e.g. ten) weeks to about several (e.g. ten) months.

As an illustrative embodiment, the aggregate of mesoporous microparticles can be directly applied to soil, either on the surface of the ground or under the ground. In another embodiment, the water-containing aggregate can be applied to soil, rocks, plants, seeds and irrigation water. Alternatively, the water-containing aggregate can be mixed with various types of soil and applied to the ground. Alternatively, the water-containing aggregate can be mixed with other soil supplements such as a fertilizer and applied to soil. In some other embodiments, the aggregate of mesoporous microparticles can be applied during watering, for example.

The frequency and the time of application of the aggregate and the amount of the aggregate can be determined according to a particular use. For example, the water-containing aggregate can be applied to the area or subject that needs the water-containing aggregate anytime around the year with any proper amount of the aggregates. In some illustrative examples, the aggregate of mesoporous microparticles containing the target material can be mixed with soil in a ratio (the amount of soil to the amount of aggregates) of about 1:1, 1:2, 1:3, 1:4, 1:5, 1:6, 1:7, 1:8, 1:9, or 1:10 to about 1:2, 1:3, 1:4, 1:5, 1:6, 1:7, 1:8, 1:9, 1:10 or 1:20. In other embodiments, the aggregate of mesoporous microparticles containing water can be added to soil, for example, in an amount of from about 0.0001 g/cm² of soil 0.001 g/cm², 0.005 g/cm², 0.01 g/cm², 0.05 g/cm², 0.1 g/cm², 0.5 g/cm², 1.0 g/cm², 1.5 g/cm², 2.0 g/cm², 2.5 g/cm², 3.0 g/cm², 3.5 g/cm², 4.0 g/cm², 4.5 g/cm², 5.0 g/cm², 5.5 g/cm², 6.0 g/cm², 6.5 g/cm², 7.0 g/cm², 7.5 g/cm², 8.0 g/cm², 8.5 g/cm², 9.0 g/cm², 9.5 g/cm², or 10 g/cm² to about 0.001 g/cm² soil, 0.005 g/cm², 0.01 g/cm², 0.05 g/cm², 0.1 g/cm², 0.5 g/cm², 1.0 g/cm², 1.5 g/cm², 2.0 g/cm², 2.5 g/cm², 3.0 g/cm², 3.5 g/cm², 4.0 g/cm², 4.5 g/cm², 5.0 g/cm², 5.5 g/cm², 6.0 g/cm², 6.5 g/cm², 7.0 g/cm², 7.5 g/cm², 8.0 g/cm², 8.5 g/cm², 9.0 g/cm², 9.5 g/cm², 10 g/cm² or 20 g/cm². In other illustrative examples, the aggregate can be applied to soil, about once a year to about 50 times a year (i.e. about once per week), or alternatively, once per day or more often. In various embodiments, the aggregate can be applied to soil, for example, about one to ten times, eleven to twenty times, twenty-one to thirty times, thirty-one to forty times, or forty-one to fifty times a year. In an alternative example, the water-containing aggregate can be applied to the area or subject that needs the water-containing aggregate several times per year with any suitable amount of the aggregates.

Some other embodiments relate to the use of aggregated mesoporous microparticles that include a target material, for example, one or more of a fertilizer, a pesticide, an herbicide, a fungicide, a biocide, a probiotic, and combinations thereof to promote plant growth. Generally, the fertilizer can be selected from nitrogen, phosphorus, potassium, calcium, sulfur, magnesium, boron, chlorine, manganese, iron, zinc, copper, molybdenum, selenium and combinations thereof. A pesticide, an herbicide, a fungicide, a biocide, and a probiotic can generally be a synthetic chemical, a biological material produced or extracted from living or dead organisms, a synthetic or natural toxin, any kind of microorganisms and combinations thereof.

The aggregated mesoporous microparticles that include the target material can generally be produced as described elsewhere in this specification. The target material captured in the aggregate of mesoporous microparticles can be slowly released to the surrounding environment during a certain extended time period. Generally, the average time to at least partially release the target material captured in the aggregate of mesoporous microparticles is from about several (e.g. ten) seconds to about several (e.g. ten) years. In certain embodiments, the average time to at least partially release the target material captured in the aggregate of mesoporous microparticles can generally be from about several (e.g. ten) seconds, several (e.g. ten) minutes, several (e.g. ten) hours, several (e.g. ten) days, several (e.g. ten) weeks, or several (e.g. ten) months to about several (e.g. ten) minutes, several (e.g. ten) hours, several (e.g. ten) days, several (e.g. ten) weeks, several (e.g. ten) months, or several (e.g. ten) years. In some embodiments, the average time to at least partially release the target material captured in the aggregate of mesoporous microparticles can generally be about several (e.g. ten) weeks to about several (e.g. ten) months.

There are at least two mechanisms of releasing the target material captured in the aggregate of mesoporous microparticles. First, the target material can be released through one or more pores. As the general condition of the target material captured in the pore present in the aggregate is liquid or gel, the target material can slowly leak from the pore into soil, rocks, plants, seeds, irrigation water, and any other area or subject in contact with or in the vicinity of the aggregate. Second, the target material can be released by natural breakdown or erosion. For example, target material can be provided or applied to soil, rocks, plants, seeds, irrigation water, and any other area or subject in contact with or in the vicinity of the aggregate, after which the aggregate can degrade or erode, for example, due at least in part to natural erosion. The time for degradation of the aggregate generally can be, for example, several (e.g. ten) minutes to several (e.g. ten) years. In some embodiments, the time for degradation of the aggregate can be, for example, several (e.g. ten) days to about a year. In other embodiments, the time for degradation of the aggregate can be, for example, several (e.g. ten) months to about a year. Therefore, the effect of the target material can last for a long period of time from the time of application.

The aggregated mesoporous microparticles that include the target material can be applied in a variety of areas and subjects that need the target material or can contact with the areas or subjects in need of the target material. Examples of such applicable areas and subjects are, but not limited to, soil, rocks, part of or whole plants, seeds, and irrigation water provided to plants and soil. Moreover, the aggregate of mesoporous microparticles that includes the target material can be applied to any area or subject that can contact with soil, rocks, part of or whole plants, seeds, and irrigation water.

In some embodiments, the target material-containing aggregate can be applied to plants and seeds. In one example, when seeds can be buried or plants are planted in soil, about 0.1 g to equal to or less than 10 g of the aggregate comprising the target material can be buried close to seeds and roots of plants. In another example, when seeds are buried or plants are planted in soil, more than 10 g to equal to or less than 25 g of the aggregate comprising the target material can be buried close to seeds and roots of plants. In still another example, when seeds are buried or plants are planted in soil, more than 25 g to about 50 g of the aggregate comprising the target material can be buried close to seeds and roots of plants. The target material can be provided to seeds and plants for any period of time, including several (e.g. ten) seconds to several (e.g. ten) years.

As an illustrative embodiment, the target material-containing aggregate of mesoporous microparticles can be directly applied to soil, either on the surface of the ground or under the ground. In another embodiment, the target material-containing aggregate can be applied to soil, rocks, plants, seeds and irrigation water. Alternatively, the target material-containing aggregate can be mixed with various types of soil and applied to the ground. Alternatively, the target material-containing aggregate can be mixed with other soil supplements such as a fertilizer and applied to soil.

The frequency and the time of application of the target material-containing aggregate and the amount of the aggregate can be determined according to a particular use. For example, the target material-containing aggregate can be applied to the area or subject in which the target material is desired anytime throughout the year with any amount of the aggregates appropriate to deliver a desired amount of target material. Illustrative examples of ratios of soil to aggregates, as well as examples of the mass of aggregates per unit area of soil include those described above in connection with the water-containing aggregates of mesoporous microparticles. Similarly, examples of the number of times aggregate can be applied to soil also include those described above in connection with the water-containing aggregates.

It is also feasible for the water-containing aggregate of mesoporous microparticles to be used with the target material-containing aggregate of mesoporous microparticles. For example, the water-containing aggregate can be applied to soil and the fertilizer-containing aggregate can be applied to plants that are planted in soil where the water-containing aggregate is applied. This combinatorial application of different types of the aggregates can be done simultaneously or sequentially. It should be apparent to a person skilled in the art in view of the disclosure that there are many different combinatorial applications with the various types of aggregates possible. Also embodiments in this application should be considered to include all possible combinatorial applications with the various types of aggregates.

Some embodiments relate to a methods of slowing and/or reversing desertification using the aggregate of mesoporous microparticles. Several examples of areas at risk of becoming desert are known throughout the Earth. Of particular concern, are areas at risk of becoming desert that are near populated areas or near productive farm land. One example of such an area is the northwestern part of China where desertification has recently been proceeding at a rate approaching 2500 square kilometers each year. Many other such areas have already become desert and an efficient method to reverse desertification that has already occurred is an important need.

One efficient way to slow and/or reverse desertification of a land is providing plants to the land. However, planting may not be easily done in desert lands, for example, due to the lack of water and suitable soil. In such occasions, the water-containing aggregate of mesoporous microparticles can be efficiently used not only to provide water to soil, but also to protect water from being quickly evaporated around new plantings.

Generally, the water-containing aggregate can be applied to a land that is at risk of being a desert or already a desert in order to reverse or slow down desertification. Some aspects relate to methods that can be performed at anytime of the year, with any frequency, and/or with any proper amount. However, as noted above, it can be particularly desirable to apply the aggregate during dry seasons. As another example, the water-containing aggregate generally can be added to soil before seeding or planting. Alternatively, the water-containing aggregate generally can be added to soil at the time of seeding or plating. In addition, the water-containing aggregate can be continuously applied every several (e.g. ten) hours, several (e.g. ten) days, several (e.g. ten) weeks or several (e.g. ten) months after seeding or planting.

In some embodiments, the water-containing aggregate of mesoporous microparticles can be added to soil without planting or seeding. Moreover, the water-containing aggregate can be added to soil during or after the rainfall to store water longer in soil.

In some other embodiments, the aggregate of mesoporous microparticles that includes the target material, for example, one or more of a fertilizer, a pesticide, an herbicide, a fungicide, a biocide, a probiotic, and combinations thereof, can generally be provided or applied to a land that is at risk of being a desert or already at least partially a desert in order to promote plant growth which can help to slow and/or reverse desertification.

Generally, the aggregate of mesoporous microparticles that include the target material can be added to soil anytime around the year with any frequency and any proper amount. The aggregate of mesoporous microparticles that include the target material can be added to soil before seeding or planting. Alternatively, the aggregate of mesoporous microparticles that include the target material can be added to soil before seeding or planting and also at the time of seeding or plating. Moreover, the aggregate of mesoporous microparticles comprising the target material can be continuously applied after seeding or planting.

In certain embodiments, the aggregate of mesoporous microparticles that include water and/or the target material can be applied to plants and seeds. For example, when seeds are buried or plants are planted in soil, the aggregate comprising water or the target material individually or in combination can be buried close to seeds and roots of plants. Therefore, water and the target material can be provided to seeds and plants for an extended time period such as several (e.g. ten) seconds to several (e.g. ten) years.

In some embodiments, the aggregate of mesoporous microparticles that include water or the target material can be applied to plants and seeds. Any amount can be applied, for example, according to the environment, type of plant, growth conditions, etc. For example, when seeds are buried or plants are planted in soil, about 0.1 g to equal to or less than 50 g of the aggregate of mesoporous microparticles that include water or the target material can be buried close to seeds and roots of plants. In one such example, about 0.1 g to equal to or less than 10 g of the aggregate of mesoporous microparticles comprising water or the target material can be buried close to seeds and roots of plants. In another example, when seeds are buried or plants are planted in soil, more than 10 g to equal to or less than 25 g of the aggregate of mesoporous microparticles that includes water or the target material can be buried close to seeds and roots of plants. For some other examples, when seeds are buried or plants are planted in soil, more than 25 g to about 50 g of the aggregate of mesoporous microparticles that includes water or the target material can be buried close to seeds and roots of plants. Therefore, water and/or the target material can be provided to seeds and plants for an extended time period such as several (e.g. ten) seconds to several (e.g. ten) years.

As an illustrative embodiment, the aggregate of mesoporous microparticles that includes water and/or the target material can be applied directly to soil, either on the surface of the ground or under the ground. In another embodiment the aggregate of mesoporous microparticles that includes water or the target material can be applied to soil, rocks, plants, seeds and irrigation water. Alternatively, the aggregate of mesoporous microparticles that includes water or the target material can be mixed with various types of soil and applied to the ground. Alternatively, the aggregate of mesoporous microparticles that includes water or the target material can be mixed with other soil supplements such as a fertilizer and applied to soil.

The frequency and the time of application of the target material-containing aggregate and the amount of the aggregate can be determined according to a particular use. For example, the target material-containing aggregate can be applied to the area or subject in which the target material is desired anytime throughout the year with any amount of the aggregates appropriate to deliver a desired amount of target material. For application to plants and seeds in soil, illustrative examples of ratios of soil to aggregates, as well as examples of the mass of aggregates per unit area of soil include those described above in connection with the water-containing and target material-containing aggregates of mesoporous microparticles. Similarly, examples of the number of times aggregate can be applied to soil also include those described above in connection with the water-containing and target material-containing aggregates.

In some other embodiments, combinatorial applications of the various types of aggregates that include water or the target material to slow and/or reverse desertification are further provided. For example, the water-containing aggregate can be applied to soil and the fertilizer-containing aggregate can be applied to plants that are planted in soil where the water-containing aggregate is applied. This combinatorial application of different types of the aggregates can be done simultaneously or sequentially. Such combinatorial application of the various aggregates comprising water or other target materials may synergize growth of plants in lands. Many different combinations of the various aggregates comprising water or other target materials are apparently expected to those having ordinary skill in the art and this disclosure includes all those expected combinations.

What is described in this specification can be modified in a variety of ways while remaining within the scope of the claims. Therefore all embodiments disclosed herein should be considered as illustrative embodiments of the present disclosure and should not be considered to represent the entire scope of the disclosure.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of plural and/or singular terms herein, those having skill in the art can translate from the plural to the singular and/or from the singular to the plural as is appropriate to the context and/or application. The various singular/plural permutations may be expressly set forth herein for sake of clarity.

In referring to time periods herein, the term “several” can denote any number that is two or more. Nevertheless, in general, the term is intended to encompass a number that is less than the number that is ordinarily used in connection with that time period. This number is often the number less than three of the next larger unit of time that is in everyday use. Thus, for example, for seconds, the next larger unit of time would be minutes, and the term “several seconds” would generally refer to any number of seconds of two or more and less than three minutes, i.e. 180 seconds. As another example, for hours, the next larger unit of time would be days, and the term “several hours” would generally refer to any number of hours of two or more and less than three days, i.e. 72 hours. As a final example, for years, the next larger unit of time would be decades, and the term “several years” would generally refer to any number of years of two or more and less than three decades, i.e. 30 years.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to disclosures containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. An aggregate of mesoporous microparticles, comprising:
at least one first mesoporous microparticle bound with at least one second mesoporous microparticle.

2. The aggregate of mesoporous microparticles of claim 1, wherein the at least one first mesoporous microparticle is bound to the at least one second mesoporous microparticle by one or more covalent bonds.

3. The aggregate of mesoporous microparticles of claim 1, wherein the at least one first mesoporous microparticle and the at least one second mesoporous microparticle are of a same form.

4. The aggregate of mesoporous microparticles of claim 1, wherein the at least one first mesoporous microparticle and the at least one second mesoporous microparticle are of a different form.

5. The aggregate of mesoporous microparticles of claim 2, further comprising a plurality of additional mesoporous microparticles covalently bound to one or more of the first mesoporous microparticle, the second mesoporous microparticle or each other.

6. The aggregate of mesoporous microparticles of claim 2, wherein the covalent bond comprises Si—O—Si.

7. The aggregate of mesoporous microparticles of claim 1, wherein one or more of the first and second mesoporous microparticles include a material selected from the group consisting of silica, carbon, and a combination thereof.

8. The aggregate of mesoporous microparticles of claim 1, wherein one or more of the first and second mesoporous microparticles include silica.

9. The aggregate of mesoporous microparticles of claim 1, wherein one or more of the first and second mesoporous microparticles are selected from the group consisting of MCM-41, MCM-48, MCM-50, SBA-15, and combinations thereof.

10. The aggregate of mesoporous microparticles of claim 1, wherein the one or more first mesoporous microparticles and the one or more second mesoporous microparticles include
one or more mesopores having diameters ranging from about 2 to about 50 nanometers.

11. The aggregate of mesoporous microparticles of claim 5, wherein the size of the aggregate is equal to or larger than 1 millimeter.

12. The aggregate of mesoporous microparticles of claim 10, wherein the one or more mesopores include water.

13. The aggregate of mesoporous microparticles of claim 10, wherein the one or more mesopores include a material selected from the group consisting of a fertilizer, a pesticide, an herbicide, a fungicide, a biocide, a probiotic, and combinations thereof.

14. The aggregate of mesoporous microparticles of claim 13, wherein the fertilizer is selected from the group consisting of nitrogen, phosphorus, potassium, calcium, sulfur, magnesium, boron, chlorine, manganese, iron, zinc, copper, molybdenum, selenium and combinations thereof.

15. A method of making an aggregate of mesoporous microparticles, comprising:
adding a reactive group to a first mesoporous microparticle and a second mesoporous microparticle; and
reacting the reactive groups to bind the first and second mesoporous microparticles.

16. The method of claim 15, wherein the reacting results in the formation of a covalent bond between the first and second mesoporous microparticles.

17. The method of claim 15, wherein the reactive group is a hydroxyl group.

18. The method of claim 17, wherein adding the hydroxyl group to the mesoporous microparticles comprises:
hydrating the mesoporous microparticles.

19. The method of claim 18, wherein hydrating the mesoporous microparticles comprises:
contacting the mesoporous microparticles with water to form a mixture; and
heating the mixture.

20. The method of 19, wherein heating the mixture of the mesoporous microparticles with water comprises:
boiling the mesoporous microparticles in water at about 100° C. or higher for about 1 hour or longer.

21. The method of claim 16, wherein the formation of a covalent bond comprises:
physically pressing the mesoporous microparticles at a temperature ranging from about 70° C. to about 500° C., the mesoporous microparticles having one or more reactive groups.

22. The method of claim 16, wherein the covalent bond comprises Si—O—Si.

23. A method of making a water-containing mesoporous microparticle aggregate comprising:
contacting a mesoporous microparticle aggregate with water, the mesoporous microparticle aggregate comprising one or more mesopores.

24. The method of claim 23, wherein the water enters the one or more mesopores of the mesoporous microparticle aggregate via capillary action.

25. A method of making a target material-containing mesoporous microparticle aggregate, comprising:
contacting a mesoporous microparticle aggregate with a target material selected from the group consisting of a fertilizer, a pesticide, an herbicide, a fungicide, a biocide, a probiotic, and combinations thereof, the mesoporous microparticle aggregate comprising one or more mesopores.

26. The method of claim 25, wherein the target material is in liquid or gel state and at least partially fills the one or more mesopores via capillary action.

27. The method of claim 25, wherein the fertilizer is selected from the group consisting of nitrogen, phosphorus, potassium, calcium, sulfur, magnesium, boron, chlorine, manganese, iron, zinc, copper, molybdenum, selenium and combinations thereof.

28. A method of retaining water in soil, comprising:
contacting the aggregate of mesoporous microparticles of claim 12 with soil.

29. A method of promoting growth of a plant, comprising:
providing an aggregate of mesoporous microparticles of claim 13 to a substrate.

30. The method of claim 29, further including retaining water in soil comprising:
providing an aggregate of mesoporous microparticles comprising water to a substrate.

31. The method of claim 30, wherein the substrate is one or more selected from the group consisting of soil, a rock, water, a plant, a seed, irrigation water and combinations thereof.

32. A method of slowing and/or reversing desertification comprising:
applying an aggregate of mesoporous microparticles of claim 12 to a land at risk of becoming a desert or a desert.

33. The method of claim 32, further comprising:
applying an aggregate of mesoporous microparticle comprising a target material, wherein the target material is selected from the group consisting of a fertilizer, a pesticide, an herbicide, a fungicide, a biocide, a probiotic, and combinations thereof to a land at risk of becoming a desert or a desert.

34. A mesoporous microparticle, comprising:
a Si—OH group on the mesoporous particle.
